(19) United States
(12) Patent Application Publication
(10) Pub. No.: US 2026/0036803 A1
(43) Pub. Date: Feb. 5, 2026

(54) BINOCULARS

(71) Applicant: GUANGDONG SIRUI OPTICAL CO., LTD, Zhongshan (CN)

(72) Inventors: Jie Li, Zhongshan (CN); Kunyi Lin, Zhongshan (CN)

(73) Assignee: GUANGDONG SIRUI OPTICAL CO., LTD, Zhongshan (CN)

(21) Appl. No.: 18/882,817

(22) Filed: Sep. 12, 2024

(30) Foreign Application Priority Data
Jul. 30, 2024 (CN) 202421828608.9

(51) Int. Cl. G02B 23/02; G02B 25/00

(52) U.S. Cl. CPC G02B 23/02; G02B 25/001

(57) ABSTRACT

An optical system of binoculars includes a first object biconvex lens of positive focal power, a second object meniscus lens of negative focal power, a third object meniscus lens of positive focal power, a fourth object meniscus lens of negative focal power, a half pentaprism, a roof prism, a first eyepiece biconcave lens of negative focal power, a second eyepiece biconvex lens of positive focal power, a third eyepiece biconvex lens of positive focal power, a fourth eyepiece meniscus lens of negative focal power, and a fifth eyepiece meniscus lens of positive focal power. These are sequentially arranged along an optical axis direction from an object side to an observation side. When focusing, the fourth object lens moves along the optical axis direction. The binoculars include an exit pupil diameter range of 3.5 mm-4.5 mm, an exit pupil distance range of 15-18 mm, and a field angle range of 6°-6.5°.

### CROSS-REFERENCE TO RELATED APPLICATION

This application claims priority to Chinese applications 202421828608.9 Jul. 30, 2024, whose disclosure is incorporated by reference in its entirety.

### TECHNICAL FIELD

Aspects of the invention generally relate to optical technical field. In particular, embodiments of the invention relate to binoculars.

### BACKGROUND

Binoculars are used to magnify distant objects through an optical system and allow them to enter the human eye, making it easier to observe details. They can be used for observing outdoor activities, watching games, watching concerts, etc. The optical systems of existing binoculars have different effects due to different design concepts. Existing binoculars have the defects of low resolution and poor user experience, unfortunately.

### SUMMARY

Therefore, embodiments of the invention provide a set of binoculars while attempting to solve technical problems and overcome the defects of low resolution and poor user experience of the existing binoculars.

In order to solve the above technical problems, aspects of the invention provide a technical solution as follows:

An optical system of binoculars includes an object lens group, a prism group applying the Behan prism principle (“Behan prism group”), and an eyepiece group arranged in sequence from an object side to an observer's side along an optical axis.

In some embodiments, the object lens group includes a first object biconvex lens of a positive focal power, a second object meniscus lens of a negative focal power, a third object meniscus lens of a positive focal power, and a fourth object meniscus lens of a negative focal power arranged in sequence from the object side to the observer's side along the optical axis.

In some embodiments, the Behan prism group includes a semi-pentaprism and a roof prism arranged in sequence from the object side to the observer's side along the optical axis.

In some embodiments, the eyepiece group includes a first eyepiece biconcave lens of a negative focal power, a second eyepiece biconvex lens of a positive focal power, a third eyepiece lens of a positive focal power biconvex type, a fourth eyepiece meniscus lens of a negative focal power, and a fifth eyepiece meniscus lens of a positive focal power arranged in sequence from the object side to the observation side along the optical axis.

Further, in some embodiments, side surfaces where the first lens and the second lens of the object lens group are connected via a glue. In some embodiments, the side surfaces where the first lens and the second lens of the eyepiece lens group are connected via a glue. in some embodiments, the side surfaces where the third lens and the fourth lens of the eyepiece lens group are connected via a glue.

Further, in some embodiments, the fourth lens of the object lens group may be movably arranged along the optical axis. In yet another embodiment, the focusing from infinity to 3 meters is achieved by moving the fourth lens of the object lens group forward and backward along the optical axis.

Further, in some embodiments, the magnification of the binoculars is 10 times.

Further, in some embodiments, the exit pupil diameter range of the binoculars is about 3.5 mm-4.5 mm.

Further, in some embodiments, the exit pupil distance range of the binoculars is about 15 mm-18 mm.

Further, in some embodiments, the field of view angle range of the binoculars is about 6°-6.5°.

Further, in some embodiments, the aperture range of the first lens of the object lens group is about 30 mm-50 mm.

Further, in some embodiments, the total length of the optical system of the binoculars does not exceed 130 mm.

In some embodiments, aspects of the invention may include the following advantages: the binoculars achieve high resolution in the center of the field of view and the large field of view, and can see clear images. At the same time, the use of multiple sets of glued lenses and low-dispersion glass can greatly reduce chromatic aberration. In addition, the use of a prism combination of a semi-pentaprism and a roof prism greatly shortens the overall length of the binoculars, making the binoculars more convenient to carry.

### BRIEF DESCRIPTION OF THE DRAWING

In order to more clearly illustrate the specific embodiments of the present invention or the technical solution in the prior art, the following will briefly introduce the drawings required for the specific implementation or the prior art description. Obviously, the drawings described below are some implementations of the present invention. For those skilled in the art, other drawings may be obtained based on these drawings without creative work.

FIG. 1 is an optical structure diagram of an optical system of binoculars in an embodiment of the invention.

Reference number keys: 1, object lens group; L11, first object lens; L12, second object lens; L13, third object lens; L14, fourth object lens; 2, Behan prism group; L21, half pentaprism; L22, roof prism; 3, real image surface of object lens; 4, eyepiece group; L41, first eyepiece lens; L42, second eyepiece lens; L43, third eyepiece lens; L44, fourth eyepiece lens; L45, fifth eyepiece lens.

### DETAILED DESCRIPTION

The technical solution of the aspects of present invention will be described clearly and completely below in conjunction with the accompanying drawings. Obviously, the described embodiments are part of the embodiments of the present invention, not all of the embodiments. Based on the embodiments of the present invention, all other embodiments obtained by ordinary technicians in the field without creative work are within the scope of protection of the present invention.

In the description of the present invention, it should be noted that the orientation or position relationship indicated by the terms “center”, “up”, “down”, “left”, “right”, “vertical”, “horizontal”, “inside”, “outside”, etc. is based on the orientation or position relationship shown in the accompanying drawings, which is only for the convenience of describing the present invention and simplifying the description, rather than indicating or implying that the device or element referred to must have a specific orientation, be constructed and operated in a specific orientation, and therefore cannot be understood as a limitation of the present invention. In addition, the terms “first”, “second”, and “third” are only used for descriptive purposes and cannot be understood as indicating or implying relative importance.

Aspects of the invention may provide an optical system adapted for binoculars, which may be used to magnify distant objects through the optical system and enter the human eye, so that the details can be observed more clearly.

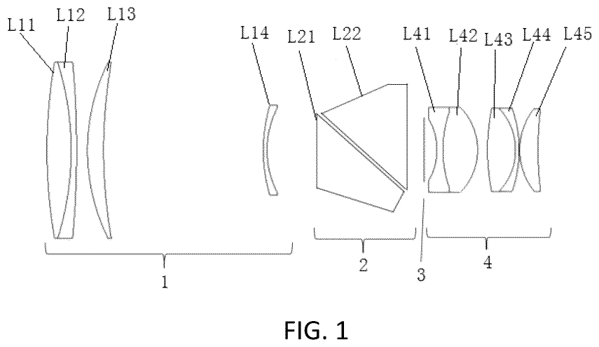

Referring now to FIG. 1, in some embodiments, the optical system of the binoculars may include an objective lens group 1, a Behan prism group 2, an objective lens real image surface 3, and an eyepiece group 4, which are arranged in sequence from the object side to the observer's side in the direction of the optical axis.

In some embodiments, the objective lens group 1 may include a first lens L11. For example, the first lens L11 may be a positive focal power biconvex object lens. In another embodiment, the object lens group 1 may include a second lens L12. In some embodiments, the second lens L12 may be a negative focal power meniscus object lens. In another embodiment, the object lens group 1 may include a third lens L13. In some embodiments, the third lens L13 may be a positive focal power meniscus object lens. In another embodiment, the object lens group 1 may include a fourth lens L14. In some embodiments, the fourth lens L14 may be a negative focal power meniscus object lens. The object lens L14 may be movably arranged along the optical axis so that the focus of the object may be from about infinity to 3 meters via moving the fourth lens L14 forward and backward along the optical axis.

In some embodiments, the Behan prism group 2 may include a half pentaprism L21 and a roof prism L22. In one aspect, such arrangement may greatly shorten a total optical length of the entire optical system and may enable an image formed by the light from the distant object after passing through the objective lens group 1 to be flipped and imaged on the real image at plane 3, as shown in FIG. 1.

In some embodiments, the eyepiece group 4 may include a first eyepiece lens L41. In some embodiments, the first eyepiece lens L41 may be a negative focal power biconcave type. In another embodiment, the eyepiece group 4 may include a second eyepiece lens L42. In some embodiments, the second eyepiece lens L42 may be a positive focal power biconvex type. In another embodiment, the eyepiece group 4 may include a third eyepiece lens L43. In some embodiments, the third eyepiece lens L43 may be a positive focal power biconvex type. In another embodiment, the eyepiece group 4 may include a fourth eyepiece lens L44. In some embodiments, the fourth eyepiece lens L44 may be a negative focal power meniscus type. In another embodiment, the eyepiece group 4 may include a fifth eyepiece lens L45. In some embodiments, the fifth eyepiece lens L45 may be a positive focal power meniscus type. The eyepiece group 4 may be used to magnify the real image surface at the plane 3, and finally the human eye can see an object with a magnification of 10 times.

Among them, in some embodiments, side surfaces of the first objective lens L11 and the second objective lens L12 may be connected via a glue. In some embodiments, the side surfaces of the first eyepiece lens L41 and the second eyepiece lens L42 are connected via a glue. In yet further embodiments, the side surfaces of the third eyepiece lens L43 and the fourth eyepiece lens L44 are connected via a glue. The connection or attachment of positive and negative lenses may greatly improve the chromatic aberration problem of the telescope. In some embodiments, at the same time, a total length of the overall optical system is shortened.

Among them, the field of view angle of the binoculars may range from 6° to 6.5°. In another embodiment, the exit pupillary diameter may range from about 3.5 mm to 4.5 mm, and the pupillary distance may range from about 15 mm to 17 mm. In one aspect, the longer pupillary distance is convenient for different groups of people to use.

In some embodiments, the aperture range of the first lens L11 of the objective lens may be about 30 mm to 50 mm, and the total length of the optical system of the binoculars may not exceed 130 mm. In one embodiment, aspects of the invention provide a small footprint or space such enable them to be versatile to different use.

Table 1 below lists the actual parameters of each lens of this embodiment that meets the above characteristics:

TABLE 1

| | | | Thick- | | |
|---|---|---|---|---|---|
| | | Y radius | ness | Refractive | Abbe |
| Lens | Number | (mm) | (mm) | Index | Number |
| First object lens | 1 | 113.732 | 7.092 | 1.484 | 83.580 |
| Second object lens | 2 | −75.473 | 1.361 | 1.792 | 28.553 |
| | 3 | −563.816 | 2.922 | | |
| Third object lens | 4 | 47.187 | 3.940 | 1.639 | 53.611 |
| | 5 | 121.585 | D (5) | | |
| Fourth object lens | 6 | 53.628 | 0.957 | 1.518 | 67.100 |
| | 7 | 27.657 | D (7) | | |
| Behan Prism Group | | / | / | / | / |
| | 8 | | 10.021 | | |
| Eyepiece first lens | 9 | −16.329 | 1.257 | 1.838 | 38.880 |
| Eyepiece second | 10 | 29.123 | 8.522 | 1.819 | 37.248 |
| lens | | | | | |
| | 11 | −15.537 | 1.447 | | |
| Eyepiece third lens | 12 | 56.325 | 6.495 | 1.524 | 55.380 |
| Eyepiece fourth | 13 | −17.732 | 0.747 | 1.865 | 18.567 |
| lens | | | | | |
| | 14 | −28.383 | 0.134 | | |
| Eyepiece fifth lens | 15 | 10.507 | 4.532 | 1.704 | 42.518 |
| | 16 | 53.379 | 16.625 | | |

The air spacing parameters of the binoculars may vary as shown in Table 2 below:

TABLE 2

| Object | | |
|---|---|---|
| distance | Infinity | 3 meters |
| D (5) | 40.15 | 43.11 |
| D (7) | 10.75 | 7.79 |

In some embodiments, among them, D(5) may be the central air gap between the third object meniscus lens L13 and the fourth object meniscus lens L14 of the object lens group (1) in the direction of the optical axis. In another embodiment, D(7) may be the central air gap between the fourth object meniscus lens L14 and the Behan prism group 2 in the direction of the optical axis.

In summary, according to aspects of the invention, the binoculars of embodiments of the invention may include the following advantages:

First, the binoculars may achieve high resolution in the center of the field of view and a large field of view, and the use of multiple groups of cemented lenses and low-dispersion glass may greatly reduce chromatic aberration.

Second, the overall structure of the binoculars may be compact, with the advantages of small size and lightweight.

Third, the prism combination of a semi-pentaprism and a roof prism is used, which greatly shortens the overall length of the binoculars and is more convenient.

Obviously, the above embodiments are merely examples for the purpose of clear disclosure, and are not intended to limit the implementation. For those skilled in the art, other different forms of changes or modifications may be made based on the above description. It is not necessary and impossible to list all the implementation methods here. The obvious changes or modifications derived therefrom are still within the scope of protection of the invention.

What is claimed is:

1. An optical system of binoculars comprising:
an object lens group (1), a Behan prism group (2), and an eyepiece group (4) arranged in sequence from an object side to an observer's side along an optical axis;
wherein the object lens group (1) comprises a first object biconvex lens (L11) of a positive focal power, a second object meniscus lens (L12) of a negative focal power, a third object meniscus lens (L13) of a positive focal power, and a fourth object meniscus lens (L14) of a negative focal power, arranged in sequence from the object side to the observer's side along the optical axis;
wherein the Behan prism group (2) comprises a half pentaprism (L21) and a roof prism (L22) arranged in sequence from the object side to the observer's side along the optical axis;
wherein the eyepiece group (4) comprises a first eyepiece biconcave lens (L41) of a negative optical focal length, a second eyepiece biconvex lens (L42) of a positive optical focal length, a third eyepiece biconvex lens (L43) of a positive optical focal length, a fourth eyepiece meniscus lens (L44) of a negative optical focal length, and a fifth eyepiece meniscus lens (L45) of a positive optical focal length.

2. The optical system of binoculars of claim 1, wherein the first object biconvex lens (L11) and the second object meniscus lens (L12) of the object lens group (1) are glued together along their connecting side surfaces;
wherein the, the side surfaces where the first eyepiece biconcave lens (L41) and the second eyepiece biconvex lens (L42) of the eyepiece group (4) are glued together along their connecting side surfaces, and
wherein the side surfaces where the third eyepiece biconvex lens (L43) and the fourth eyepiece meniscus lens (L44) of the eyepiece group (4) are glued together along their connecting side surfaces.

3. The optical system of binoculars of claim 1, wherein the (L14) of the object lens group (1) is movably arranged along the optical axis, and wherein the fourth object meniscus lens (L14) of the object lens group (1) is configured to move along the optical axis to achieve focusing from infinity to 3 meters.

4. The optical system of binoculars of claim 1, further comprising a magnification of 10 times.

5. The optical system of binoculars of claim 1, further comprising an exit pupil diameter thereof ranges from about 3.5 mm to 4.5 mm.

6. The optical system of binoculars of claim 1, further comprising a pupillary distance thereof ranges from about 15 mm to 18 mm.

7. The optical system of binoculars of claim 1, further comprising a field of view thereof about 6° to 6.5°.

8. The optical system of binoculars of claim 1, wherein the first object biconvex lens (L11) comprises an aperture in a range of 30 mm to 50 mm.

9. The optical system of binoculars of claim 1, further comprising a total length not exceeding 130 mm.
